(19) United States
(12) Patent Application Publication
(10) Pub. No.: US 2022/0358364 A1
(43) Pub. Date: Nov. 10, 2022

(54) SYSTEMS AND METHODS FOR CONSTRUCTING AN ARTIFICIAL INTELLIGENCE (AI) NEURAL-LIKE MODEL OF A REAL SYSTEM

(71) Applicant: Incucomm, Inc., Addison, TX (US)

(72) Inventor: Randal Allen, Orlando, FL (US)

(73) Assignee: Incucomm, Inc., Addison, TX (US)

(21) Appl. No.: 17/652,082

(22) Filed: Feb. 22, 2022

Related U.S. Application Data
(63) Continuation-in-part of application No. 16/674,942, filed on Nov. 5, 2019.
(60) Provisional application No. 63/200,200, filed on Feb. 21, 2021.

(51) Int. Cl. G06N 3/08; G06N 3/04

(52) U.S. Cl. CPC G06N 3/08; G06N 3/04

(57) ABSTRACT

Architecture and related method of constructing a model of a real system, including constructing an initial neural-like representation of the real system with a combination of layers, the layers comprising mathematical functions including at least one independent variable; inputting a first set of known data to the initial neural-like representation to generate a corresponding set of output data, the known data comprising values for the at least one independent variable of the neural-like representation; feeding the corresponding set of output data of the initial neural-like representation and a second set of known data correlated to the first set of known data, to a comparator, the comparator generating error signals representing a difference between members of the set of output data and correlated members of the second set of known data; and, iteratively varying a weight parameter of at least one of the combination of terms comprising the initial neural-like representation to produce a refined neural-like representation of the real system until a measure of the error signals is reduced to a value wherein the set of corresponding output data of the refined neural-like representation over a desired range is approximately equivalent to the second set of known data.

### CROSS-REFERENCE TO RELATED APPLICATIONS

This application claims the benefit of U.S. Provisional Patent Application Ser. No. 63/200,200, filed on Feb. 21, 2021, and is a continuation-in-part, and claims the benefit, of co-pending U.S. patent application Ser. No. 16/674,942, filed Nov. 5, 2019, which claims the benefit of U.S. Provisional Patent Application No. 62/756,044, entitled “HYBRID AI,” filed Nov. 5, 2018, each of which is incorporated herein by reference.

This application is related to U.S. patent application Ser. No. 15/611,476 entitled “PREDICTIVE AND PRESCRIPTIVE ANALYTICS FOR SYSTEMS UNDER VARIABLE OPERATIONS,” filed Jun. 1, 2017, which is incorporated herein by reference.

This application is also related to U.S. Provisional Application No. 62/627,644 entitled “DIGITAL TWINS, PAIRS, AND PLURALITIES,” filed Feb. 7, 2018, converted to U.S. application Ser. No. 16/270,338 entitled “SYSTEM AND METHOD THAT CHARACTERIZES AN OBJECT EMPLOYING VIRTUAL REPRESENTATIONS THEREOF,” filed Feb. 7, 2019, which are each incorporated herein by reference.

This application is further related to U.S. application Ser. No. 16/674,848, entitled “SYSTEM AND METHOD FOR STATE ESTIMATION IN A NOISY MACHINE-LEARNING ENVIRONMENT,” filed Nov. 5, 2019, U.S. application Ser. No. 16/674,885, entitled “SYSTEM AND METHOD FOR ADAPTIVE OPTIMIZATION,” filed Nov. 5, 2019, and U.S. application Ser. No. 16/675,000, entitled “SYSTEM AND METHOD FOR VIGOROUS ARTIFICIAL INTELLIGENCE,” filed Nov. 5, 2019, each of which are incorporated herein by reference.

### REFERENCES

Each of the references cited below are incorporated herein by reference.

Nonpatent Literature Documents:

Sutton, R. S., and Barto, A. G., “Reinforcement Learning: An Introduction” (2018)

Kaplan A., and Haenlein, K., “Siri, Siri in my Hand, who's the Fairest in the Land?” (2018)

Chen, R. T. Q., Rubanova, Y., Bettencourt, J., and Duvenaud, D. “Neural Ordinary Differential Equations” (2018)

Jain, P, and Kar, P., “Non-Convex Optimization for Machine Learning” (2017)

Taleb, N., “The Black Swan—The Impact of the Highly Impossible” (2010)

Haken, H., “Information and Self-Organization” (2010)

Bazaraa, M, et al., “Nonlinear Programming: Theory and Algorithms” (2006)

Fouskakis, D., and Draper, D., “Stochastic Optimization: A Review” (2001)

Kelso, J. A. S., “The Self-Organization of Brain and Behavior” (1995)

Rumelhart, D. E., Hinton, G. E., and Williams, R. J., “Learning representations by back-propagating errors” (1986)

### TECHNICAL FIELD

The present disclosure is directed, in general, to artificial intelligence systems and, more specifically, to a system and method for constructing a mathematical model of a system in an artificial intelligence environment.

### BACKGROUND

Kaplan and Haenlein define Artificial Intelligence (AI) as “a system's ability to correctly interpret external data, to learn from such data, and to use those learnings to achieve specific goals and tasks through flexible adaptation.” AI dates to the mid-1950s with times of promise followed by disappointment and lack of funding. However, AI has seen a resurgence due to increased computational power, the ability to manipulate large amounts of data, and an influx of commercial research funding.

For the purposes of this disclosure, assume machine learning is a subset of AI (FIG. 1), with applications to image, speech, voice recognition, and natural language processing. In business applications, machine learning may be referred to in the context of predictive analytics. Unlike computer programs which execute a set of instructions, machine learning is based on models which learn from patterns in the input data. A major criticism of machine learning models is that they are black boxes without explanation for their reasoning.

There are three types of machine learning which depend on how the data is being manipulated. Supervised learning trains a model on known input and output data to predict future outputs. There are two subsets to supervised learning: regression techniques for continuous response prediction and classification techniques for discrete response prediction. Unsupervised learning uses clustering to identify patterns in the input data only. There are two subsets to unsupervised learning: hard clustering where each data point belongs to only one cluster and soft clustering where each data point can belong to more than one cluster. Reinforcement learning trains a model on successive iterations of decision-making, where rewards are accumulated because of the decisions. It will be apparent to those skilled in the art how this present invention is applicable to both deep reinforcement applications and to classic reinforcement, but with the superior form of networks described herein. A person having ordinary skill in the art will recognize there are many methods to solve these problems, each having their own set of implement requirements. Table 1 (below) shows a sampling of machine learning methods in the state of the art.

TABLE 1

| Regression | Classification | Soft Clustering | Hard Clustering |
|---|---|---|---|
| Ensemble methods | Decision trees | Fuzzy-C means | Hierarchical clustering |
| Gaussian process | Discriminant analysis | Gaussian mixture | K-means |
| General linear model | K-nearest neighbor | | K-medoids |
| Linear regression | Logistic regression | | Self-organizing maps |
| Nonlinear regression | naïve Bayes | | |
| Regression tree | Neural nets | | |
| Support vector machine | Support vector machine | | |

Current focus is on deep learning, a subset of machine learning (see FIG. 1). Applications include face, voice, and speech recognition and text translation which employ the classification form of supervised learning. Deep learning gets its name from the multitude of cascaded artificial neural networks. FIG. 2 shows a typical artificial neural network architecture used in machine learning. In its most basic form, the artificial neural network has an input layer, a hidden layer, and an output layer. For deep learning applications, the more layers, the deeper the learning. FIG. 3 shows a simplistic artificial neural network architecture used in deep learning where additional hidden layers have been added providing depth. In practice, deep learning networks may have tens of hidden layers. It will be apparent to those skilled in the art how the present invention is applicable to network constructs which are the equivalent of Multilayer Perceptrons (MLPs), Convolutional Neural Networks (CNNs), and Recurrent Neural Networks (RNNs) but with the advantages described herein.

As an example of the burden on the model designer, consider the application of supervised machine learning (classification) for object recognition or detection. The designer must manually select the relevant features to extract from the data, decide which classification method to use to train the model, and tune hyperparameters associated with fitting the data to the model. The designer does this for various combinations of features, classifiers, and hyperparameters until the best results are obtained.

In the case of deep learning, the manual step of selecting the relevant features to extract from the data is automated. However, to accomplish this, thousands of images are required for training and testing. Also, the designer is still responsible for determining the features. In the end, even highly experienced data scientists can't tell whether a method will work without trying it. Selection depends on the size and type of the data, the insights sought, and how the results will be used.

While artificial neural networks are the basis for artificial intelligence, machine learning, and deep learning, there are problems associated with this technology. Significant issues include lack of transparency, depth of deep learning, under-fitting or over-fitting data, cleaning the data, and hidden-layer weight selection.

Because the artificial neural network was modeled after the human brain, it is difficult to see the connection between the inputs and outputs, which leads to a lack of transparency. The designer is often unable to explain why one architecture is used over another. This unknown opaqueness leaves the user wondering if the architecture can be trusted. For the designer, architectural selection becomes an exercise in numerical investigation. Architectural choices naturally include the number of inputs and outputs but becomes artificial when hidden layers and corresponding nodes are added. The number of hidden layers and the number of nodes comprise the depth of deep learning and is arbitrary. If you happen upon an architecture that appears to work, congratulations, but good luck explaining why to the user. Furthermore, architecture selection is based on the number of hidden layers and nodes: too few may lead to under-fitting, whereas too many may lead to over-fitting. In both cases, the overall performance and predictive capability may be compromised.

Other problems with artificial neural networks are the need to clean the data and, seemingly arbitrary, weight selection. Why should some data (outliers) be omitted from the training or test set? Maybe there is a plausible reason for the outlier's existence, and it should be kept because it represents reality. For instance, maybe the outlier represents what is known as a black swan—Nassim Taleb's metaphor for an improbable event with colossal consequences. The outlier should not be omitted simply to make the architecture more robust. Also, who is to say which weight factor should be placed on a hidden layer or set of nodes? Data cleansing and parameter tuning may lead to architectural fragility.

Upon surveying the prior art associated with machine learning in general, those skilled in the art will recognize the disadvantages of current methods. Refer again to FIG. 2 for a sampling of the state of the art, where each method has its own set of implementation requirements. In the case of supervised classification, the designer is required to manually select features, choose the classifier method, and tune the hyperparameters.

Deep learning brings with it its own set of demands. Enormous computing power through high performance graphics processing units (GPUs) is needed to process the data, lots of data. The number of data points required is on the order of 10⁵ to 10⁶. Also, the data must be numerically tagged. Plus, it takes a long time to train a model. In the end, because of the depth of complexity, it's impossible to understand how conclusions were reached.

The mathematical theory associated with artificial neural networks is the Universal Approximation Theorem (UAT)—which states a network, with a single hidden layer, can approximate a continuous function. Some practitioners rely on this too heavily and seem to ignore the assumptions associated with this approach. For example, as seen in FIG. 3, a relatively simple deep learning model has more than a single hidden layer. By implementing a deep learning model with multiple hidden layers, the UAT assumption is grossly violated. Also, for practical applications serving state of the art technologies, problem complexity surely increases. Once a model has been built, the architect may not be entirely sure the mathematical functions are continuous—another violation of UAT assumptions. While increasing the number of neurons may improve the functional approximation, any improvement is certainly offset by the curse of dimensionality. In other words, while additional neurons (for a single hidden layer) may improve the functional approximation, by increasing the number of hidden layers, the number of neurons compounds. Other version of the UAT come with their own limitations. In one version, linear outputs are assumed. In another version, convex continuous functions are assumed. The present invention can accept nonlinearities, nonconvexities, and discontinuities. One final (very relevant) comment: the UAT itself says nothing about the artificial neural network's ability to learn! With the present invention, the designer has complete control over what is being learned.

The artificial neural network architecture supporting machine/deep learning is supposedly inspired by the biologic nervous system. The model learns through a process called back propagation which is an iterative gradient method to reduce the error between the input and output data. But humans don't back-propagate when learning, so the analogy is weak in that regard. That aside, more significant issues are its black box nature and the designer having no influence over what is being learned.

Unsupervised learning is a form of machine learning used to explore data for patterns and/or groupings based on shared attributes. Typical unsupervised learning techniques include clustering (e.g., k-means) and dimensionality reduction (e.g., principal component analysis). The results of applying unsupervised learning could either stand-alone or be a reduced feature set for supervised learning classification/regression. However, these techniques also come with their limitations. With dimensionality reduction, principal component analysis requires the data to be scaled, assumes the data is orthogonal, and results in linear correlation. Nonnegative matrix factorization requires normalization of the data and factor analysis is subject to interpretation. Concerning clustering, some algorithms require the number of clusters to be selected a priori (e.g., k-means, k-medoid, and fuzzy c-means). Self-organizing maps implement artificial neural nets which come with their own disadvantages as cited above.

Therefore, a system is needed with an architecture where the designer has control over what is being learned and, thus, provides inherent elucidation. This architecture must be innovative and avoid the pitfalls of artificial neural networks with their arbitrary hidden layers, iterative feature and method selection, and hyperparameter tuning. The system must not require enormous computing power, it should quickly train and run on a laptop. Depending on the application, data tagging, while necessary, should be held to a minimum. Lastly, the system must not require thousands of (cleaned) data points. In the case of unsupervised learning, a system is needed where the number of clusters is not required a priori, data does not have to be labelled, and an artificial neural net model does not have to be trained.

### SUMMARY

To address certain deficiencies of the prior art, disclosed is an architecture and related method of constructing a model of a real system, including constructing an initial neural-like representation of the real system with a combination of layers, the layers comprising mathematical functions including at least one independent variable; inputting a first set of known data to the initial neural-like representation to generate a corresponding set of output data, the known data comprising values for the at least one independent variable of the neural-like representation; feeding the corresponding set of output data of the initial neural-like representation and a second set of known data correlated to the first set of known data, to a comparator, the comparator generating error signals representing a difference between members of the set of output data and correlated members of the second set of known data; and, iteratively varying a weight parameter of at least one of the combination of terms comprising the initial neural-like representation to produce a refined neural-like representation of the real system until a measure of the error signals is reduced to a value wherein the set of corresponding output data of the refined neural-like representation over a desired range is approximately equivalent to the second set of known data.

### BRIEF DESCRIPTION OF THE DRAWINGS

For a more complete understanding of the present disclosure, reference is now made to the following detailed description taken in conjunction with the accompanying drawings, in which:

FIG. 1 illustrates an artificial intelligence, machine learning, and deep learning hierarchy;

FIG. 2 illustrates an elementary artificial neural network model architecture;

FIG. 3 illustrates a simplistic artificial neural network model architecture for deep learning;

FIG. 4 illustrates a system architecture showing a mathematical model coupled to a subtractor;

FIG. 5 illustrates a generic mathematical model for input/output;

FIG. 6 illustrates a generic mathematical model for input/input;

FIG. 7 illustrates a mathematical model for system identification;

FIG. 8 illustrates a mathematical model for reinforcement learning;

FIG. 9 illustrates a mathematical model for Fourier series;

FIG. 10 illustrates a mathematical model for order finding;

FIG. 11 illustrates a Boolean circuit for classical logic;

FIG. 12 illustrates a mathematical model for a power series;

FIGS. 13A and 13B illustrate a mathematical model for clustering;

FIG. 14 illustrates a flow diagram of an embodiment of a method of constructing a mathematical model of a real system;

FIG. 15 illustrates a block diagram of an embodiment of an apparatus for constructing a mathematical model of a real system;

FIGS. 16A and 16B illustrate a mathematical model for training a neural net;

FIG. 17 illustrates a mathematical model for testing a neural net;

FIG. 18 illustrates a mathematical model for testing a neural net in real-time; and,

FIG. 19 illustrates a dashboard for monitoring a neural net in real-time.

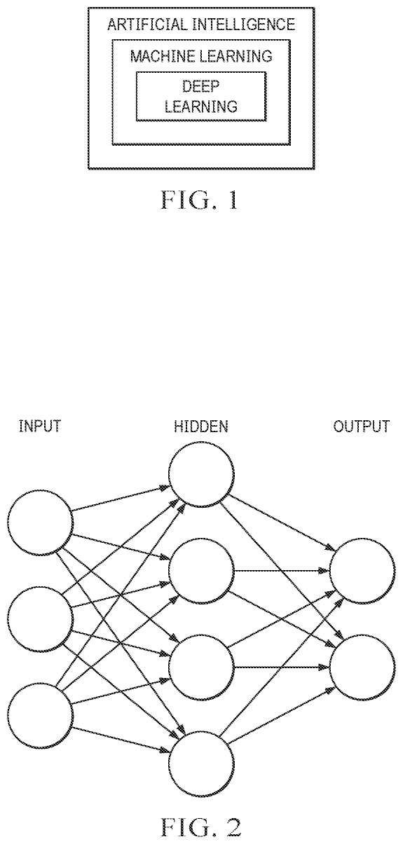

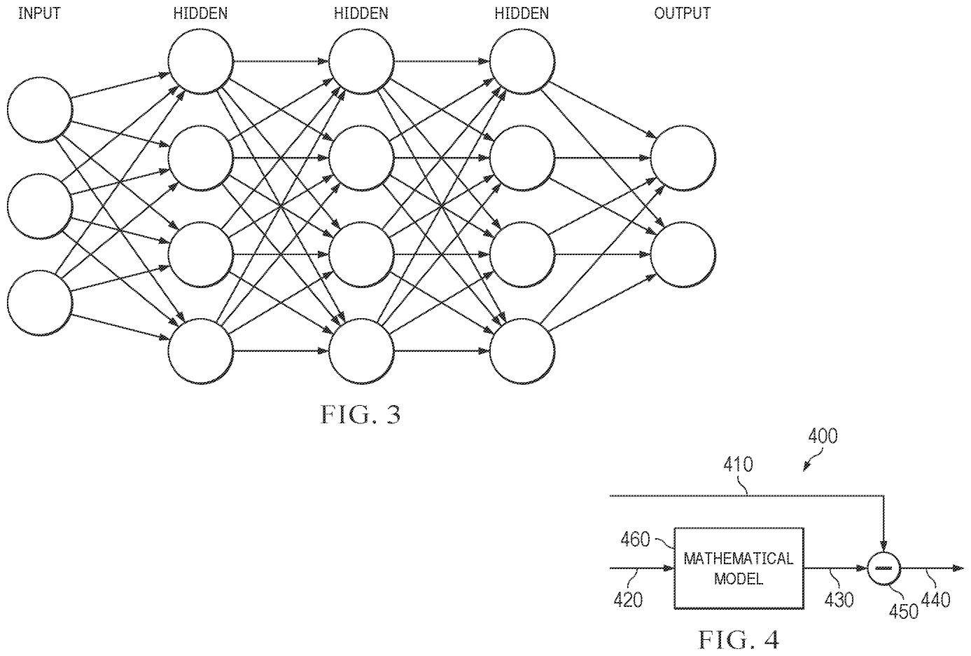

Corresponding numerals and symbols in the different figures generally refer to corresponding parts unless otherwise indicated and, in the interest of brevity, may not be described after the first instance.

### DETAILED DESCRIPTION

A unifying system architecture adaptable to a wide range of technological applications (e.g., machine, deep, and reinforcement learning; dynamic systems; cryptography; and quantum computation/information) is introduced herein. System architectures may contain nonlinearities, nonconvexities, and/or discontinuities. The designer has control over what is being learned and thus provides inherent elucidation of the results. This lends transparency and explanation to applications based on interpretable artificial neural networks. Furthermore, less data is needed to discover cause-effect relationships.

With limited success, artificial neural networks bring several disadvantages. The design process becomes an academic exercise in numerical investigation resulting in an untrusted “black box” where the designer has no influence over what is being learned. In the end, because of the depth of complexity, it is virtually impossible to understand how conclusions were reached.

A novel system architecture is introduced herein where the designer has control over what is being learned and thus provides inherent elucidation. This lends transparency and explanation to applications based on artificial neural networks. Embodiments include forms of artificial intelligence: machine, deep, and reinforcement learning; dynamic systems; cryptography; and quantum computation/information.

The making and using of the present exemplary embodiments are discussed in detail below. It should be appreciated, however, that the embodiments provide many applicable inventive concepts that can be embodied in a wide variety of specific contexts. The specific embodiments discussed are merely illustrative of specific ways to make and use the systems, subsystems, and modules for estimating the state of a system in a real-time, noisy measurement, machine-learning environment. While the principles will be described in the environment of a linear system in a real-time machine-learning environment, any environment such as a nonlinear system, or a non-real-time machine-learning environment, is well within the broad scope of the present disclosure.

Where the current state of the art creates a connection between two sets of data with a multitude of nodes, layers, and arbitrarily simple functions, the novel process introduced herein instead inserts a curated set of lucid mathematical functions between the two sets of data. This is a fundamental difference in that mathematical nonlinearities, and/or nonconvexities, and/or discontinuities can more quickly be approximated to reveal relationships between the two sets of data.

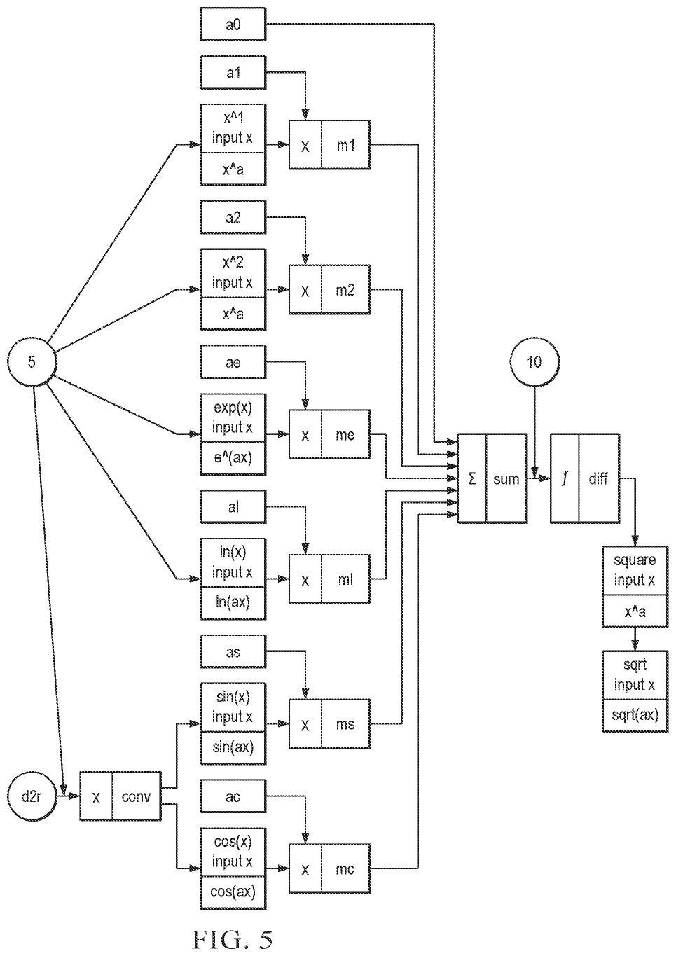

Referring to the system architecture (400) illustrated in FIG. 4, signal (420) is sent to the mathematical model (460) yielding output signal (430). The error signal (440), which is a difference (450) between the feedforward signal (410) and the output signal (430), is minimized. The mathematical model (460) may be generic or specific, depending on the application. If available, one skilled in the art should incorporate a priori knowledge into the design of the mathematical model architecture. For example, if the problem is associated with mechanical vibration, then the mathematical model (460) should include Fourier sine and cosine terms. Minimization of the error signal (440) is achieved through optimization techniques. Through this process, signal (430) is forced to match signal (410) by adjusting parameters associated with the mathematical model (460).

This approach is unique in that it serves as a unifying system architecture among the many varied specialized sciences, including machine learning (Table 1). For example, in supervised learning (classification), output is related to input. Referring again to FIG. 4, an embodiment of the proposed invention solves this type of problem by simply connecting known input data to signal (420) and known output data to signal (410). In supervised learning (regression), output is related to output. An embodiment of the novel process solves this type of problem by simply connecting known output data to signal (420) and known output data to signal (410). For both supervised learning cases, parameters associated with the mathematical model (460) are varied until the computed result matches the known result. In the case of unsupervised learning (clustering), another embodiment of the proposed invention solves this type of problem by connecting the known input to both signal (410) and signal (420). By minimizing the error, signal (430 will match signal (410) and thus, characterize the input data based on the mathematical model (460). While various embodiments leverage the same system architecture, only the assignment of signal (410), signal (420), and the mathematical model architecture differ.

Any theory has two parts: a mathematical description and an interpretation of the mathematical formulas. Clearly, the model forms the mathematical description and because of an overt design, the transparent mathematical model is interpretable and explainable.

To understand how the system operates, consider an embodiment of the system architecture (400) where the designer has no a priori knowledge about the relationships of the data. In this case, assume the mathematical model contains generic mathematical functions such as a polynomial such as a second-order polynomial function, transcendental functions such as sine and cosine terms, exponential functions, and logarithmic functions. An example sum of terms is a₀+a₁x+a₂x²+ . . . +bₛ sin(nx)+b_{c} cos(nx)+c exp(nx)+d ln(nx). Other embodiments can involve different mathematical functions and operations, including classical Boolean/logic functions or quantum logic gates. To guard against such discontinuities that can be produced by logic functions, a novel optimization algorithm is employed which avoids partial derivatives and their associated numerical instabilities.

The coefficients a₀, a₁, a₂, bₛ, b_{c}, c, d are random variables between 0 and 1 and weighted such that they sum to 1. Because the system architecture is designed to minimize a differential error between some computed quantity and a known quantity, the coefficients are changed to place different weights on each of the mathematical function. Since the coefficients are random variables, their adaptation (over multiple Monte Carlo iterations) is probabilistic. All the statistics are available such that the designer can explore any set of coefficients for interesting (rare condition) cases. Nominally, however, the designer selects the median coefficient values which define a transparent, interpretable, and explainable relationship between the known input and the computed output. The system architecture is self-defined because the coefficients are determined empirically. There is no need for the designer to perform a numerical investigation of trial and error as in the case for artificial neural nets. The system architecture is transparent, interpretable, and explainable because the designer can show the mathematical function that relates known data to computed data.

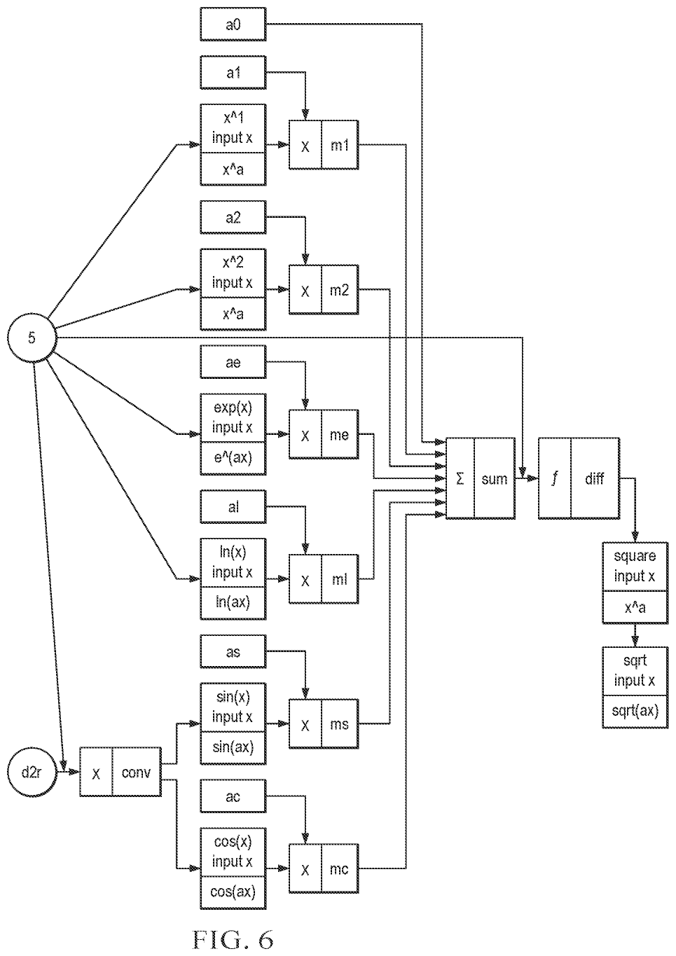

FIG. 5 refers to a generic mathematical model for input/output problems. Let the integer 5 be the known input (signal 420 of FIG. 4) and serve as the independent variable for a generic mathematical model a₀+a₁x+a₂x²+aₑ exp(nx)+aₗ ln(x)+aₛ sin(x)+a_{c} cos(x). Let the integer 10 be the known output (signal 410 of FIG. 4). Minimizing a difference between the computed output and the known output (signal 440 of FIG. 4) determines the coefficients a₀, a₁, a₂, aₑ, aₗ, aₛ, a_{c} of the mathematical functions. These coefficients describe the mathematical model and are used to explain the relationship between the input and output. FIG. 6 refers to a generic mathematical model for input/input problems and follows a similar approach as described in the preceding paragraph. However, these coefficients are used to explain the characteristics of the input. Both examples (input/output of FIG. 5 and input/input of FIG. 6) demonstrate the system architecture of the proposed invention supports a unified approach to supervised and unsupervised learning, respectively.

As a practical example, consider the process of system identification as applied to the estimation of the rolling moment aerodynamic parameter, Cₗ. One artificial neural net approach uses 5 independent variables to determine 3 dependent variables. After a preliminary exercise in numerical investigation (input/output scaling, initial network weights, number of hidden nodes, learning rate, momentum parameter, and slope factors of the sigmoidal activation functions) convergence is achieved after 2000 iterations. The result is a complex, opaque, uninterpretable, unexplainable relationship between the inputs and outputs. Also, if there are any changes to the inputs or outputs, the model must be retrained.

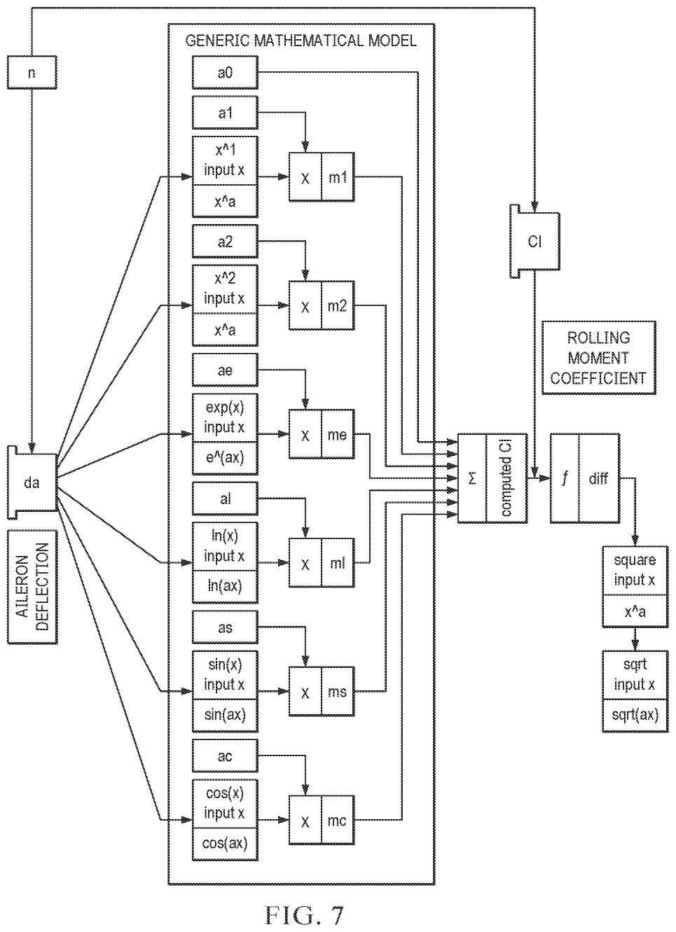

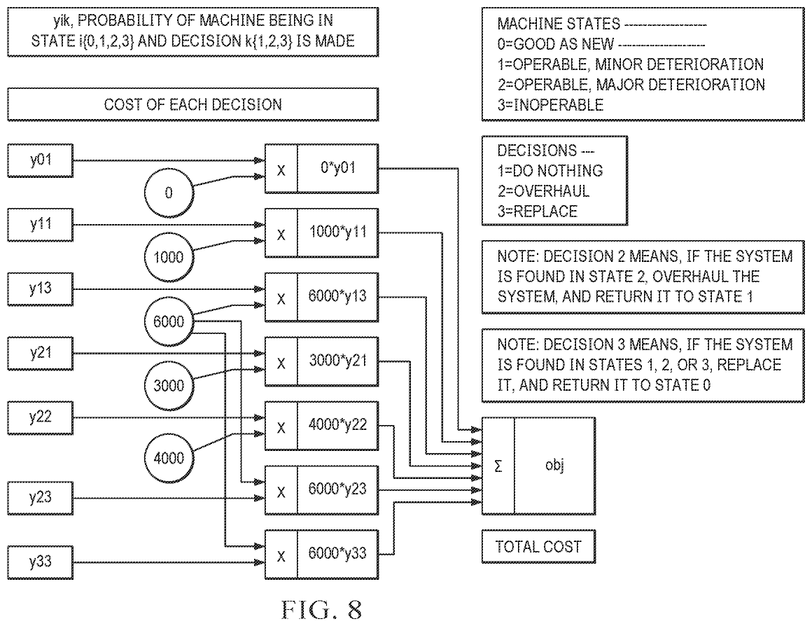

FIG. 7 refers to a mathematical model for system identification problems using the proposed invention. Let the aileron deflection be the known input (signal 420 of FIG. 4). Let the roll moment aerodynamic parameter be the known output (signal 410 of FIG. 4). One skilled in the art will recognize the direct relationship between aileron deflection and rolling moment aerodynamics. Minimizing a difference between the computed output and the known output (signal 440 of FIG. 4) determines the coefficients of the mathematical functions. Assuming the aerodynamic relationship between input and output is unknown, a generic mathematical model is used: a₀+a₁x+a₂x²+aₑ exp(nx)+aₗ ln(x)+aₛ sin(x)+a_{c} cos(x). The coefficients describe the model and are used to explain the relationship between the input (aileron deflection) and output (roll moment aerodynamic parameter). Rather than using an input/output ratio of 5:3, a 1:1 ratio is used with the proposed invention. Much less data is required to determine the relationship between the two data sets. Also, the results are achieved in 200 iterations—an order of magnitude less than required by the artificial neural net approach. Furthermore, the artificial neural net approach required the time series data to be in chronological order. The proposed invention is agnostic to any timestamp. The relationship between the two data sets is important, not the time at which they occur. While the model is still relatively complex, it is transparent, interpretable, and explainable. Because of these attributes, the proposed invention is much more reliable for flight safety certification. Finally, the mathematical model can be subsequently exercised to explore extreme cases, e.g., letting variables go to zero and letting variables approach infinity. Hence increasing confidence model deployment.

The designer has complete control over what is being learned using the novel process introduced herein. If the designer has a priori knowledge, mathematical or logical representations may or may not be included accordingly. The adaptive discovery of the proposed invention finds the best configuration of terms contributing to a scientific equation (based on a combination of elementary mathematical functions) which matches real-world observations. Because of mathematical transparency, the designer can easily interpret the results to see if they correspond with intuition and explain how the system works.

Back-propagation methods are replaced by an adaptive system for solving nonlinear, nonconvex problems. Paired with a rich set of options for mathematical functions, the system can be optimized for a training set of nearly any size. There are no restrictions on the problem space, including nonlinearities and/or discontinuities. In the case of multiple inputs/outputs, prior knowledge of the hyperspace is not needed. The mathematical architecture is independent of the input/output complexity. Inputs and outputs can be discrete, continuous, deterministic, random, or any combination thereof.

Regarding data, normalization may be performed to avoid domination by any one input. Otherwise, there is no need to manipulate the data. Furthermore, much less data is needed for the system identification architecture embodiment compared with the artificial neural net approach. This demonstrates no need for massive training sets.

There is also no need for enormous computing power. Every embodiment discussed in this specification runs on a laptop personal computer.

In the case of unsupervised learning (clustering), the number of clusters is not required to be known a priori, data does not have to be labelled, and an artificial neural net model does not have to be trained.

The novel process disclosed herein lends transparency and explanation to applications based on artificial neural networks. Benefits include, but aren't limited to, minimizing risk associated with data security legislation, reducing reliance on large, clean data sets which otherwise limit practical applications, and reducing footprint for real-time applications dominating networks, servers, and GPUs.

The following embodiments are just a few examples and are discussed with intentions to demonstrate the flexibility of the system architecture as applicable to the problem space of current technologies, e.g., reinforcement learning, cryptography, information theory, and quantum computation/information. Those skilled in these arts will understand and appreciate their content.

In one embodiment, the present invention can be used to emulate reinforcement learning. Reinforcement learning is the science of optimal decision-making. An agent, operating in an environment, is rewarded based on actions taken. The agent tries to figure out the optimal way to act within the environment. In mathematical terms, this is known as a Markov Decision Process (MDP). For this example, assume a manufacturer has a machine that is critical in the production process. The machine is evaluated each week to determine its operating condition. The state of the machine is either good as new, functioning with minor defects, functioning with major defects, or inoperable. Statistical data shows how the machine evolves over time. As the machine deteriorates, the manufacturer may select from the following options: do nothing, overhaul the machine, or replace the machine—all with corresponding immediate and subsequent costs. The manufacturer's objective is to select the optimal maintenance policy, as illustrated by the example shown in FIG. 8.

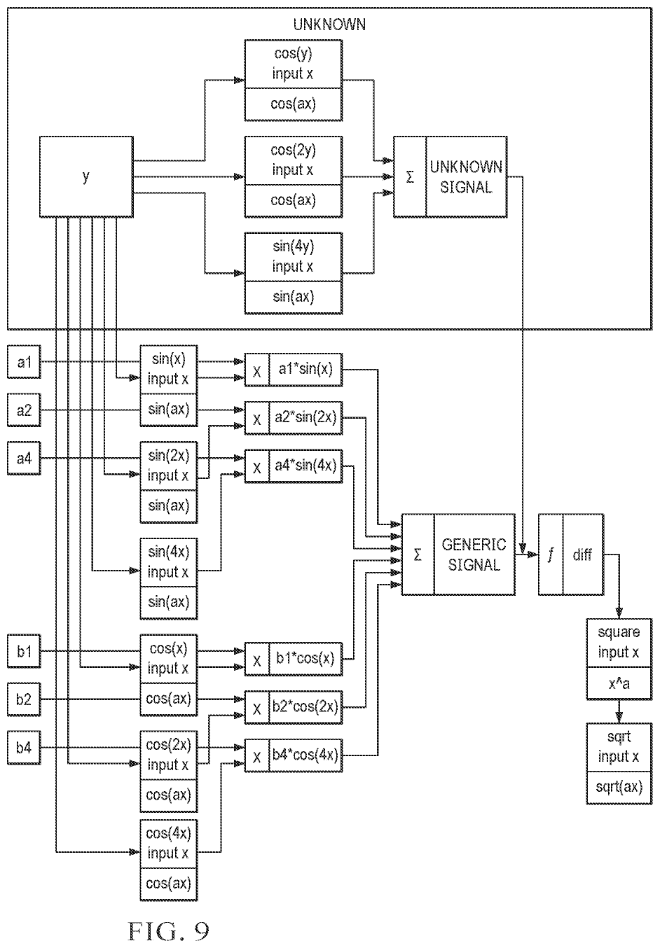

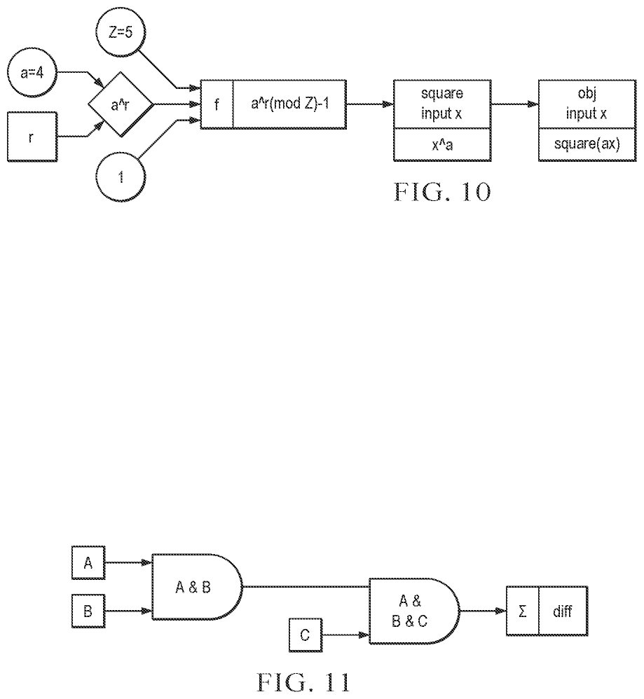

As another example, in one embodiment of the present invention (emulating cryptography) a sinusoidal signal, composed of a summation of many individual frequency components, is used as an input to a mathematical model of a discrete Fourier transform. By minimizing a difference between the computed signal and the reference signal, the reference signal is decomposed to determine its frequency content (FIG. 9). Continuing with another cryptography example, an embodiment of the present invention is used to perform the task of order finding (FIG. 10). Efficient order-finding can be used to break RSA public key cryptosystems. In this problem, the integer value of r is sought which satisfies the expression a^{r}≡1(mod N) where mod N means modulus N. In this example embodiment, the problem has been formulated as a^{r} (modN)−1, where a difference has been minimized over different integer values of r. Again, the same architectural approach is applied to a completely different problem type. Additional embodiments may be extended from Fourier transforms and cryptography to their quantum counterparts, i.e., quantum Fourier transforms and quantum cryptography.

Another example of an embodiment of the present invention (emulating Boolean logic) is a discontinuous classical circuit with three “AND” gates serving as the mathematical model (FIG. 11), i.e. A AND B AND C.

A truth table, Table 2, responsive to the binary inputs A, B, and C, showing the logical result A AND B AND C is illustrated below:

TABLE 2

| A | B | C | A & B & C |
|---|---|---|---|
| 0 | 0 | 0 | 0 |
| 0 | 0 | 1 | 0 |
| 0 | 1 | 0 | 0 |
| 0 | 1 | 1 | 0 |
| 1 | 0 | 0 | 0 |
| 1 | 0 | 1 | 0 |
| 1 | 1 | 0 | 0 |
| 1 | 1 | 1 | 1 |

Minimizing the output yields seven of the 2³=8 truth table values (0), while maximizing the output yields the final entry in a truth table, e.g., in Table 2. When maximizing this logic architecture, there is only one solution, i.e., A=B=C=1. Likewise, minimizing the architecture will yield all other results. This is significant because while some mathematical models may include many logic gates (e.g., decision-making) the complexity of the model architecture may render the problem intractable. Yet, the process introduced herein allows a practitioner to simply exercise the system to yield the corresponding truth table leading to the discovery of cause-effect relationships. Classical computation with Boolean circuits, using an acyclic directed graph, may be extended to another example embodiment of quantum computation/information by implementation of quantum circuits. These circuits form the basis for implementing various computations. While physicists and mathematicians view quantum computation as hypothetical experiments, computer scientists view quantum computation as games where players, typically Alice and Bob, optimize their performance in various abstractions. Applications include the minimization of bits for quantum error correction, and GHZ (Greenberger, Horne, and Zeilinger) and CHSH (Clauser, Home, Shimony, and Holt) games.

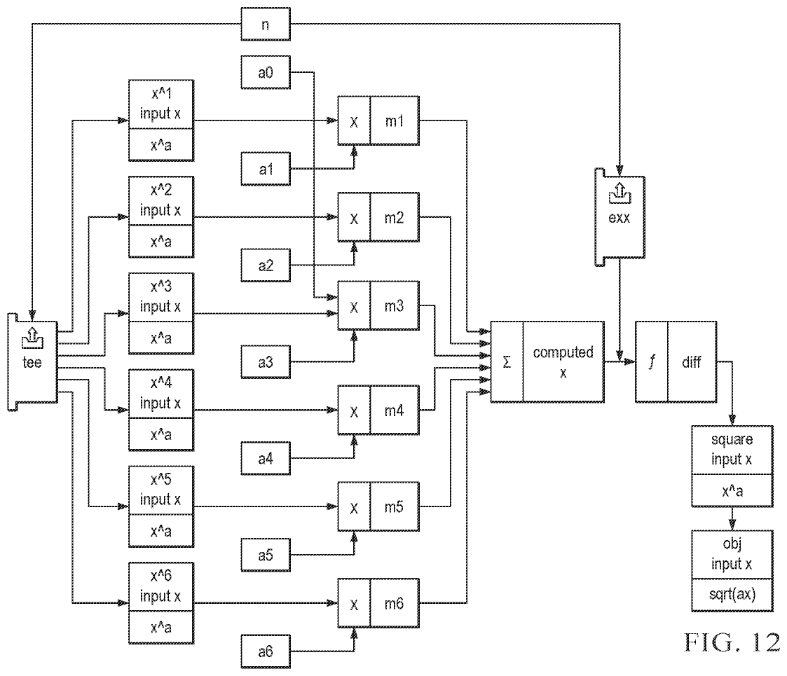

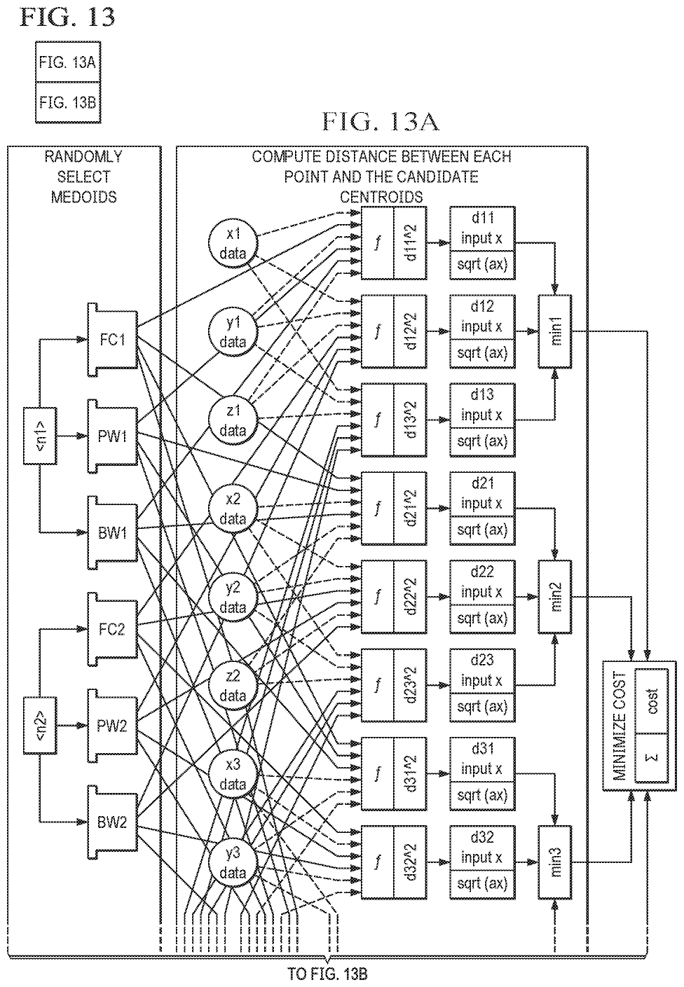

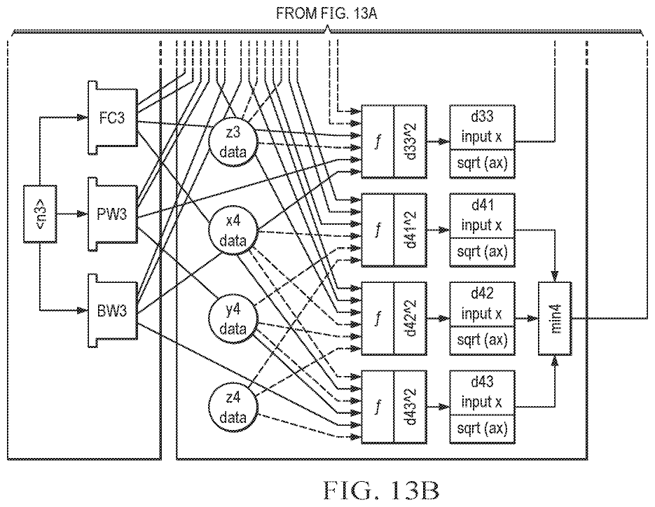

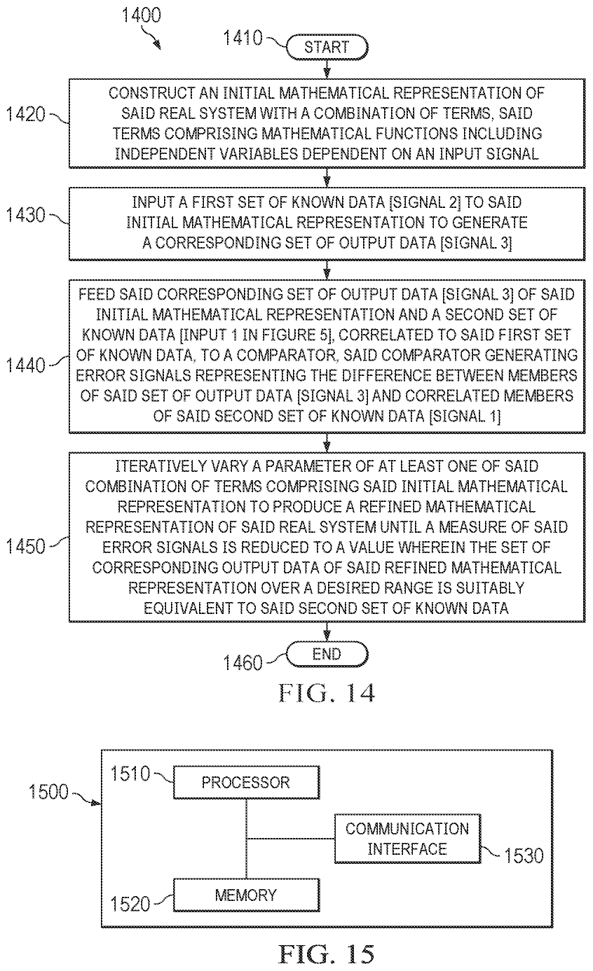

Another example of an embodiment of the present invention emulates information and self-organized complex systems. The human brain and behavior are shown to exhibit features of pattern-forming, dynamical systems, including multi-stability, abrupt phase changes, crises, and intermittency. How human beings perceive, intend, learn, control, and coordinate complex behaviors is understood through dynamic systems. Here, a dynamic system is modeled by a power series (Σₙaₙxⁿ) as a solution to an ordinary differential equation. A second-order harmonic oscillator (mass, spring, damper system) is used to create a set of input-output relations. Using the novel process introduced herein, the (spring and damping) coefficients are determined through the power series implementation of the differential equation (FIG. 12). Again, this demonstrates the flexibility of this unifying system architecture which is adaptable to a wide range of technological applications.

An example embodiment of the present invention applied to unsupervised learning is clustering. This example combines the benefits of hard and soft clustering, i.e., the number of clusters does not need to be known, data may belong to more than one cluster, ellipsoidal clusters may have different sizes. Because data does not have to be labelled, dimensionality reduction techniques (e.g., Principal Component Analysis) are unnecessary and subsequently dismissed. Also, since the approach does not use artificial neural nets, a model does not need to be trained and thus, no training data is required. Furthermore, since the approach is stochastic, it allows for black swan clusters to be identified, if they exist.

The number of clusters, k, is determined automatically. After processing the data for a given cluster number, a histogram displays the number of data points assigned to each cluster. When the histogram is uniform, the data is over-fitted. Hence, the number of clusters (k) is one less than the current number. To identify the clusters, select k random points out of the n data points as medoids. Associate each data point with the nearest medoid by selecting the minimum distance. The sum of all minimums (for each data point) is the cost (objective function). Minimize (optimize) the cost to identify the clusters. Once the clusters have been identified, it's rudimentary to determine which data point is associated with each cluster. With the data clustered accordingly, it is a simple exercise to determine the centroid of the ellipsoidal cluster.

By avoiding deep learning techniques based upon artificial neural net architectures, all corresponding disadvantages (lack of transparency, lack of explainability, and the need to reserve training data and the time spent training the artificial neural net) are dismissed. Because data does not have to be cleaned or labelled, dimensionality reduction techniques (e.g., Principal Component Analysis) are unnecessary. Instead, statistical distributions of the data are applied. This approach does not rely on “stochastic gradient descent” (random guesses at partial derivatives) which can become numerically unstable with practical conditions. Alternatively, the objective function is evaluated directly using Monte Carlo techniques. The solution is scalable and may be implemented for real-time analysis.

To conclude, consider an example embodiment for real-time systems. As one skilled in the art is aware, real-time requirements for aerospace guidance, navigation, and control processes are different than real-time requirements for e-commerce transactions. However, in either case, the system may be augmented such that known constraints (if any) could be built into the objective function a priori. Also, by selecting an appropriate resolution, the system may be configured to execute in a deterministic time frame. This single approach for multifunctional systems may be used for industrial applications. These multifunctional systems must manage diverse objectives, multiple resources, and numerous constraints. A factory might use several types of power (e.g., pneumatic, electrical, and hydraulic), several types of labor skills, many different raw materials, all while making multiple products. A production optimization system based on the Industrial Internet of Things (IIoT) can collect data from thousands of sensors. A system with the computational efficiency to support real-time monitoring and control is a valuable advance in optimization techniques.

Again, the foregoing embodiments serve as examples across relevant technologies and are not meant to be exhaustive.

Turning now to FIG. 14, illustrated is a flow diagram of an embodiment of a method 1400 of constructing a mathematical model of a system that can be a real system. The method 1400 is operable on a processor such as a microprocessor coupled to a memory. The method 1400 begins at a start step or module 1410.

At a step or module 1420, an initial mathematical representation of the system is constructed with a combination of terms, the terms comprising mathematical functions including independent variables dependent on an input signal. The combination of terms includes at least one of a transcendental function, a polynomial function, and a Boolean function. A transcendental function can be a trigonometric function, a logarithmic function, an exponential function, or another analytic function.

At a step or module 1430, a first set of known data (corresponding to the signal 420 in FIG. 4) is inputted to the initial mathematical representation to generate a corresponding set of output data (corresponding to signal 430 in FIG. 4).

At a step or module 1440, the corresponding set of output data (corresponding to the signal 430 in FIG. 4) of the initial mathematical representation and a second set of known data (corresponding to the signal 410 in FIG. 4) correlated to the first set of known data, is fed to a comparator, the comparator generating error signals (corresponding to the signal 440 in FIG. 4) representing a difference between members of the set of output data (corresponding to the signal 430 in FIG. 4) and correlated members of the second set of known data (corresponding to the signal 410 in FIG. 4).

In one embodiment, the first set of known data and the second set of known data respectively comprise known input data and corresponding known output data for the real system; as such, this represents a supervised-classification learning mode. In another embodiment, the first set of known data and the second set of known data both comprise known output data for the real system; as such, this represents a supervised-regression learning mode. In a third embodiment, the first set of known data and the second set of known data both comprise known input data for the system; as such, this represents an unsupervised-clustering learning mode.

In an embodiment, the first set of known data and the second set of known data are a subset of all known data for the real system. As an example, the signal 420 illustrated in FIG. 4 can have multiple values. In a related embodiment, the subset of all known data is utilized to produce the refined mathematical representation of the real system and remaining data is utilized to test the refined mathematical representation for coherence over a fuller range of data.

At a step or module 1450, a parameter of at least one of the combination of terms comprising the initial mathematical representation is iteratively varied to produce a refined mathematical representation of the real system until a measure of the error signals is reduced to a value wherein the set of corresponding output data of the refined mathematical representation over a desired range is suitably equivalent to the second set of known data.

In an embodiment, the measure of the error signals corresponds to a maximum error signal for the first and second sets of known data. In an alternative embodiment, the measure of the error signals is a root-mean-square (RMS) value of the error signals.

In an embodiment, the step of iteratively varying a parameter of at least one of the combination of terms includes setting the coefficient of each term to a value between 0 and 1 such that all coefficients sum to 1. Setting the coefficient of each term to a value between 0 and 1 can be employed to normalize the terms.

The method 1400 terminates at end step or module 1460.

Turning now to FIG. 15, illustrated is a block diagram of an embodiment of an apparatus 1500 for—constructing a mathematical model of a system. The apparatus 1500 is configured to perform functions described hereinabove of constructing the mathematical model of the system. The apparatus 1500 includes a processor (or processing circuitry) 1510, a memory 1520 and a communication interface 1530 such as a graphical user interface.

The functionality of the apparatus 1500 may be provided by the processor 1510 executing instructions stored on a computer-readable medium, such as the memory 1520 shown in FIG. 15. Alternative embodiments of the apparatus 1500 may include additional components (such as the interfaces, devices and circuits) beyond those shown in FIG. 15 that may be responsible for providing certain aspects of the device's functionality, including any of the functionality to support the solution described herein.

The processor 1510 (or processors), which may be implemented with one or a plurality of processing devices, perform functions associated with its operation including, without limitation, performing the operations of constructing the mathematical model of the system. The processor 1510 may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The processor 1510 may include, without limitation, application processing circuitry. In some embodiments, the application processing circuitry may be on separate chipsets. In alternative embodiments, part or all of the application processing circuitry may be combined into one chipset, and other application circuitry may be on a separate chipset. In still alternative embodiments, part or all of the application processing circuitry may be on the same chipset, and other application processing circuitry may be on a separate chipset. In yet other alternative embodiments, part or all of the application processing circuitry may be combined in the same chipset.

The memory 1520 (or memories) may be one or more memories and of any type suitable to the local application environment and may be implemented using any suitable volatile or nonvolatile data storage technology such as a semiconductor-based memory device, a magnetic memory device and system, an optical memory device and system, fixed memory and removable memory. The programs stored in the memory 1520 may include program instructions or computer program code that, when executed by an associated processor, enable the respective device 1500 to perform its intended tasks. Of course, the memory 1520 may form a data buffer for data transmitted to and from the same. Exemplary embodiments of the system, subsystems, and modules as described herein may be implemented, at least in part, by computer software executable by the processor 1510, or by hardware, or by combinations thereof.

The communication interface 1530 modulates information for transmission by the respective apparatus 1500 to another apparatus. The respective communication interface 1530 is also configured to receive information from another processor for further processing. The communication interface 1530 can support duplex operation for the respective other processor 1510.

As described above, the exemplary embodiments provide both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a processor. In particular, in the case of firmware or software, the exemplary embodiments can be provided as a computer program product including a computer readable storage medium embodying computer program code (i.e., software or firmware) thereon for execution by the computer processor. The computer readable storage medium may be non-transitory (e.g., magnetic disks; optical disks; read only memory; flash memory devices; phase-change memory) or transitory (e.g., electrical, optical, acoustical or other forms of propagated signals-such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Thus, as introduced herein, the novel unified system architecture is adaptable to a wide range of technological applications. The unified system architecture is employed to construct a mathematical model of a system. The system architecture produces results that are transparent, interpretable, and can be used for explainable artificial intelligence. Control can be exercised over what is being learned by the model. The model may contain nonlinearities, nonconvexities, and discontinuities. Less data is needed for the model to discover cause-effect relationships.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

Building on the foregoing “Evolved Artificial Intelligence” (“Evolved AI”), the following disclosure demonstrates the principles of Evolved AI for one skilled in the art of neural networks (neural nets), including a description of the approach taken to implement a mainstream neural net within the Evolved AI system architecture.

### Data

One skilled in the art of artificial intelligence/machine learning will recognize the Iris dataset as equivalent to a “hello world” application when learning a new computer programming language. The Iris data set features four physical measurements of the flower's attributes, e.g., sepal length, sepal width, petal length, and petal width. These features are used to classify three varieties of irises: Setosa, Versicolor, and Virginica.

As is typically done, the four physical measurements are normalized according to their z-score. This is accomplished by first computing the average and standard deviation of the data, e.g., sepal length. Then, the z-score is computed by subtracting the average from each data point value and dividing the difference by the standard deviation. Z-scores typically lie in the range of −3 to +3, with negative (positive) z-score values representing data below (above) the mean.

Finally, the data is allocated for training and testing purposes. Typically, 80% of the data is allocated to training, while 20% is reserved for testing. However, one skilled in the art may choose any ratio of training-to-testing.

Other embodiments may extend the feature set to any number of inputs and any number of classification outputs. Other embodiments may choose to use raw data or apply other normalization methods. Even in the case of z-score normalization, which is a Gaussian or normal distribution, one could sort the data to be sure “edge” cases—those that are out in the “tails” of the z-score distributions—are part of the training set. In fact, the entire training set could be composed of only edge cases. Referring to the Iris data set, an embodiment of normalization could be sorting the z-scores within a particular class (Setosa) and selecting two opposing points from the sepal width normal distribution—one at the left-end of the tail and one at the right-end of the tail. A similar approach may be taken for the other features (sepal length, petal width, and petal length) to obtain a subtotal of eight edge case points and for the other classes (Versicolor and Virginica) resulting in a total of 24 edge cases. This approach dismisses the need for “big” data. For the 150-point Iris data set, this amounts to only needing 16% of the data for training purposes.

### Architecture

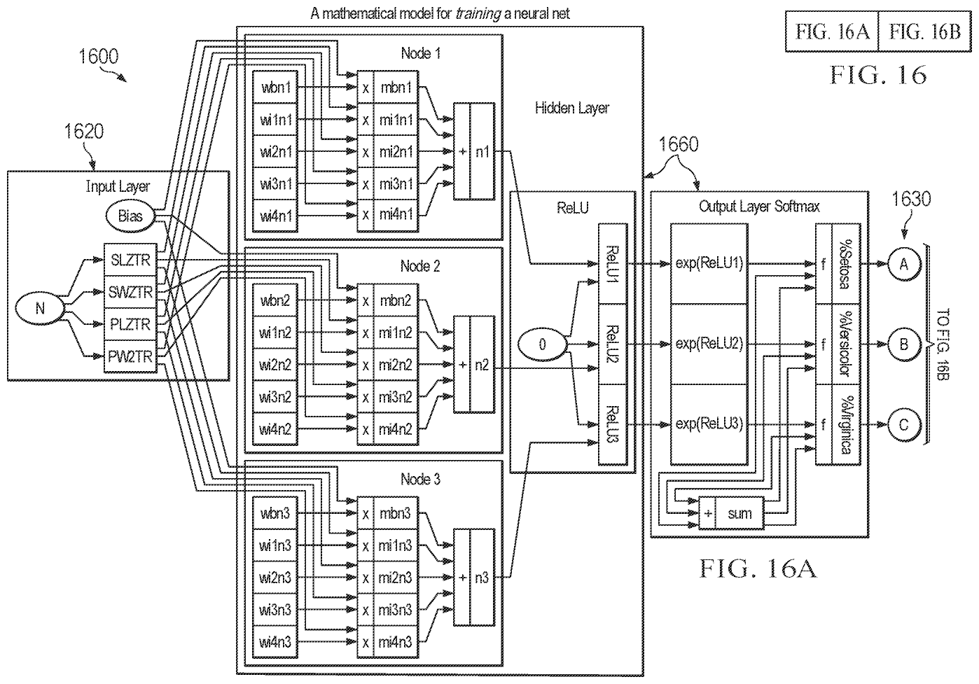

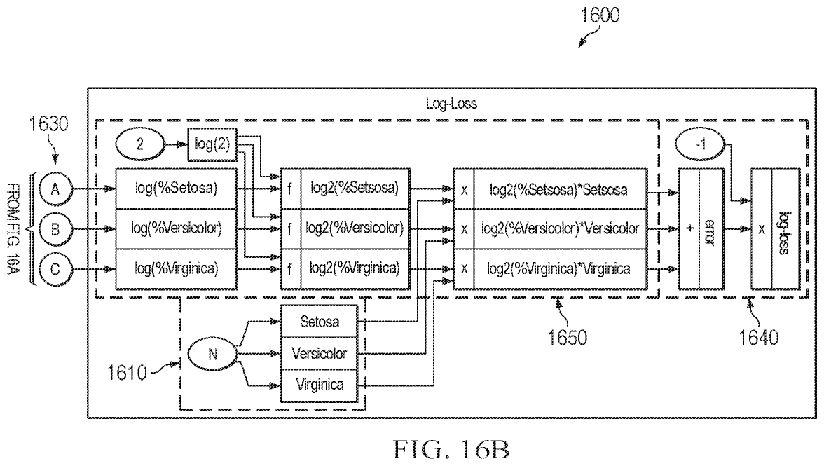

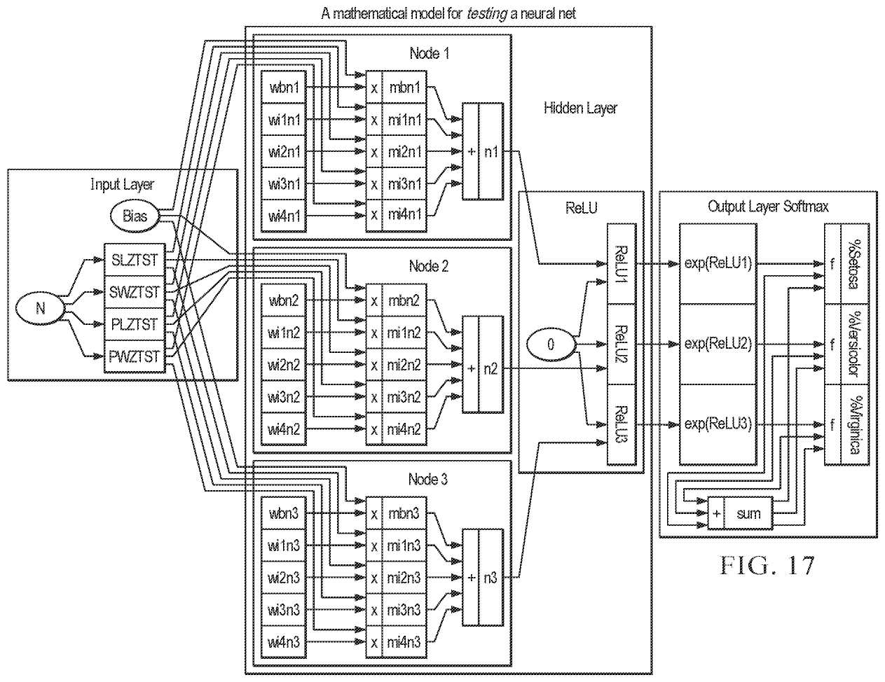

FIGS. 16A and 16B illustrate an example model 1600 for training a neural net (analogous to 460 of FIG. 4); the text references within that figure, and the subsequent two figures, are defined as:
Bias—a bias node (set to 1)
SLZTR—Sepal length z-score training
SWZTR—Sepal width z-score training
PLZTR—Petal length z-score training
PWZTR—Petal width z-score training
N—An index to select a particular data set
wbn1, wbn2, wbn3—Weights applied to bias for nodes 1, 2, 3, respectively
wi1n1, wi2n1, wi3n1, wi4n1—Weights applied to inputs 1, 2, 3, 4 (resp.) for node 1
wi1n2, wi2n2, wi3n2, wi4n2—Weights applied to inputs 1, 2, 3, 4 (resp.) for node 2
wi1n3, wi2n3, wi3n3, wi4n3—Weights applied to inputs 1, 2, 3, 4 (resp.) for node 3
mbn1, mbn2, mbn3—Multipliers applied to bias for nodes 1, 2, 3, respectively
mi1n1, mi2n1, mi3n1, mi4n1—Multipliers applied to inputs 1, 2, 3, 4 (resp.) for node 1
mi1n2, mi2n2, mi3n2, mi4n2—Multipliers applied to inputs 1, 2, 3, 4 (resp.) for node 2
mi1n3, mi2n3, mi3n3, mi4n3—Multipliers applied to inputs 1, 2, 3, 4 (resp.) for node 3
n1, n2, n3—Nodes 1, 2, 3, respectively
0—The constant zero
ReLU1, ReLU2, ReLU3—The Rectified Linear Unit activation function
exp(ReLU1), exp(ReLU2), exp(ReLU3)—The exponential of ReLU1, 2, 3, respectively
sum—The summation of the exponentials, used for normalization
% Setosa, % Versicolor, % Virginica—The probability of Setosa, Versicolor, Virginica, respectively
2—The constant two
log(2)—The base 10 logarithm of 2
log(% Setosa), log(% Versicolor), log(% Virginica)—The base 10 logarithm of % Setosa, % Versicolor, % Virginica, respectively
log2(% Setosa), log2(% Versicolor), log2(% Virginica)—The base 2 logarithm of % Setosa, % Versicolor, % Virginica, respectively
Setosa, Versicolor, Virginica—The training classification for each type
log2(% Setosa)*Setosa, log2(% Versicolor)*Versicolor, log2(% Virginica)*Virginica—The product of the base 2 logarithm of % Setosa (% Versicolor, % Virginica) multiplied by the Setosa (Versicolor, Virginica) classifier, respectively
error—The summation of all base 2 logarithms multiplied by their classifiers
−1—The constant negative one
log-loss—The log-loss function

At a high level, (left to right), there is an input layer 1620 (analogous to input 420 in FIG. 4), a “hidden” layer consisting of three “nodes” and an activation function, an output layer—which is a percentage for classification, and a cost function needed for optimization of the weights (i.e., 1420 of FIG. 14).

The input layer 1620 consists of the normalized input data (sepal length and width, petal length and width), a bias input, and a node to select a data vector. For example, if the selection is the number six, then the sixth vector set of sepal (length, width) and petal (length, width) is chosen.

Next, the “hidden layer” and output layer (collectively 1660) are analogous to the mathematical model 460 illustrated in FIG. 4. The hidden layer is somewhat of a misnomer, retained here for one skilled in the art of neural nets. Any subsystem within the Evolved AI system architecture is not hidden and is free to be constructed according to the practitioner's preference. Within the hidden layer, there are three nodes, again nomenclature retained for one skilled in the art. Three nodes are constructed in alignment with the three different iris classifications. Had there been additional classification types, the architecture would assign correspondingly additional nodes. Within each node is a summation of weighted inputs and a weighted bias. Weights may be limited in many ways. In this example, a range of −1 to +1 is used.

Continuing, the next subsystem shows the activation function. The literature refers to many types of activation functions including linear, step, sigmoid, and hyperbolic tangent functions. However, the rectified linear unit (ReLU) function is currently the most popular activation function being implemented in deep learning, so it is implemented here.

The next portion of the subsystem architecture is a mathematical way to determine the classification probability. Depending on the input vector selection and the summation of weights, a percentage (accomplished through an exponential function used to normalize the output) is computed to designate the probability of each classification. One skilled in the art will recognize this as the softmax function.

Finally, with the Evolved AI system architecture (i.e., FIG. 4), a cost function needs to be minimized. For regression problems, the mean squared error is minimized. For classification problems, the logarithmic loss (log-loss) error function 1650 (analogous to 450 in FIG. 4) is implemented.

Other embodiments may or may not include the bias node. While it appears to be essential in artificial neural nets, it is certainly not required in the Evolved AI system architecture.

In other embodiments, the practitioner may choose to implement any number of “hidden” layers and nodes.

Also, other embodiments for the weights include different ranges, e.g. 0 to 1, −5 to +5, −100 to +23. In the Evolved AI system architecture, these are random variables and as such may be any probability distribution (e.g., uniform, normal, etc.) the practitioner desires. Furthermore, if desired, the practitioner may place constraints on the weights as in the case of a weighted average.

Other embodiments may or may not include the “all important” activation function. The purpose of the activation function is to inject nonlinearity into an otherwise linear construct as is the case for artificial neural nets. In the Evolved AI architecture, the practitioner may construct any nonlinear architecture desired, including discontinuities associated with Boolean logic gates, or quantum logic gates. Given a quantum computer, Evolved AI could implement quantum logic gates (just as it currently does for Boolean logic gates) to build a real-time cognitive model mimicking human thinking.

While the mean-square-error cost function is used for regression problems and the log-loss function is used for classification problems, other embodiments of the cost function could be implemented for optimization, e.g., root-mean-square, root-sum-square, etc.

### Training

Training consists of selecting an input vector (i.e., 1430 of FIG. 14), applying a summation of weights (and a bias), and ultimately computing a classification probability. For each input vector there is a corresponding variety classification (i.e., 1440 of FIG. 14). Therefore, the probability should be one for a single variety and zero for the remaining two. Of course, this is not the case initially, so the weights must be optimized to minimize the error between a certain variety and its corresponding probability.

One skilled in the art of neural networks will typically expect some form of back propagation to be the method for optimizing the weights. However, with the Evolved AI system architecture, nonlinear, nonconvex, stochastic optimization is used. (See U.S. Patent Pub. No. US 2020/0192777, Jun. 18, 2020, System and Method for Adaptive Optimization) Here, each input vector is selected with weights being optimized over many Monte Carlo iterations. The result (i.e., 1450 of FIG. 14) is a statistical collection of weights grouped by classification type. Optimal weights are extracted from the stochastic results by selecting median values. The usual tradeoffs apply, tighter convergence tolerances and additional Monte Carlo iterations lead to longer execution times.

Other embodiments for optimal weight selection might include different statistical measures, e.g., their mean values or the peak of their respective histograms.

### Testing

For testing, referring to FIG. 17, the model is preferably pared-down to eliminate the cost function (log-loss) subsystem portion. It is no longer needed since testing does not require optimization. Also, the input data is changed from the training set to the testing set.

To test the model using optimal weights (now constants, rather than random variables), each test vector is run through the model and the probabilities for the three classification types are observed. If the largest probability corresponds exactly with the type, the identification is correct, otherwise it's not. The results are captured in what one skilled in the art will recognize as a confusion matrix.

The confusion matrix is a square matrix with the classification types across the top row and down the first column. Ideally, the matrix will have 1s along the diagonal and 0s in the off-diagonal cells. Table 1 below show the confusion matrix for the iris dataset based on the simple neural net model shown in FIGS. 16A and 16B.

TABLE 1
Confusion Matrix

| C-Matrix | Setosa | Versicolor | Virginica |
|---|---|---|---|
| Setosa | 1 | 0 | 0 |
| Versicolor | 0 | 0.64 | 0.36 |
| Virginica | 0 | 0.16 | 0.84 |

In testing, Setosa is correctly classified for 100% of the test cases. Versicolor is correctly classified for 64% of the test cases. In 36% of the cases, it is “confused” with Virginica. Finally, Virginica is correctly classified for 84% of the test cases. In 16% of the cases, it is “confused” with Versicolor. One skilled in the art familiar with the iris data set will not be surprised by these results. In scatterplots, Setosa is clearly separated from the other two; while Versicolor and Virginica overlap.

Still, it is prudent to investigate why some of the data vectors were misclassified. Four of the Versicolor and one of the Virginica data vectors contain points that are at the edge of the z-score range. So, some of the misclassification may be due to z-score normalization. Eliminating these data points improves the confusion matrix as shown in Table 2.

TABLE 2
Confusion Matrix (improved)

| C-Matrix | Setosa | Versicolor | Virginica |
|---|---|---|---|
| Setosa | 1 | 0 | 0 |
| Versicolor | 0 | 0.86 | 0.14 |
| Virginica | 0 | 0.12 | 0.88 |

One skilled in the art may consider the neural net model (FIGS. 16A and 16B) to be an oversimplification.

### Real-Time

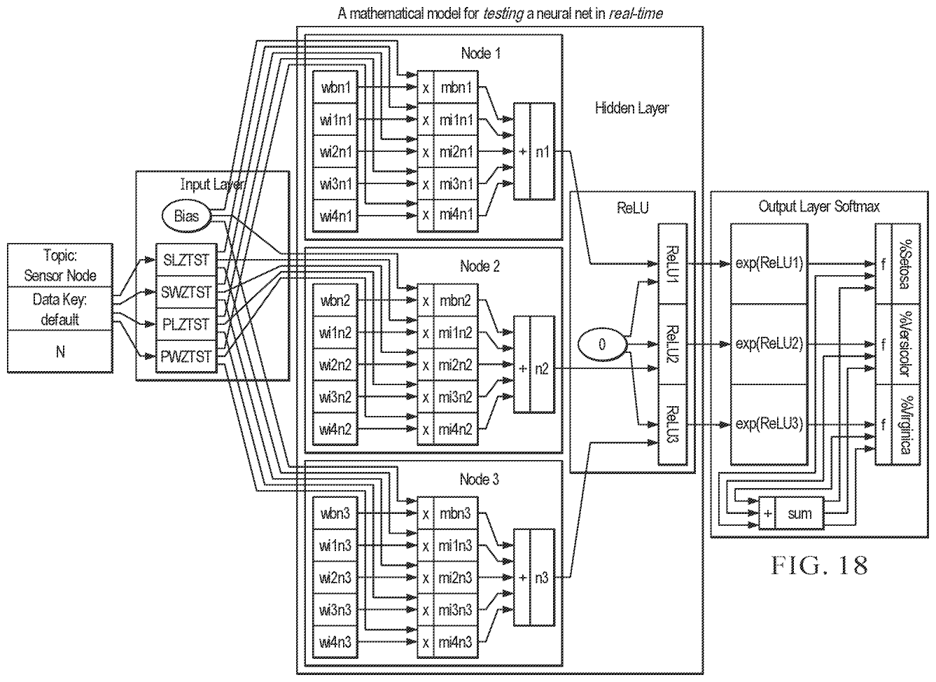

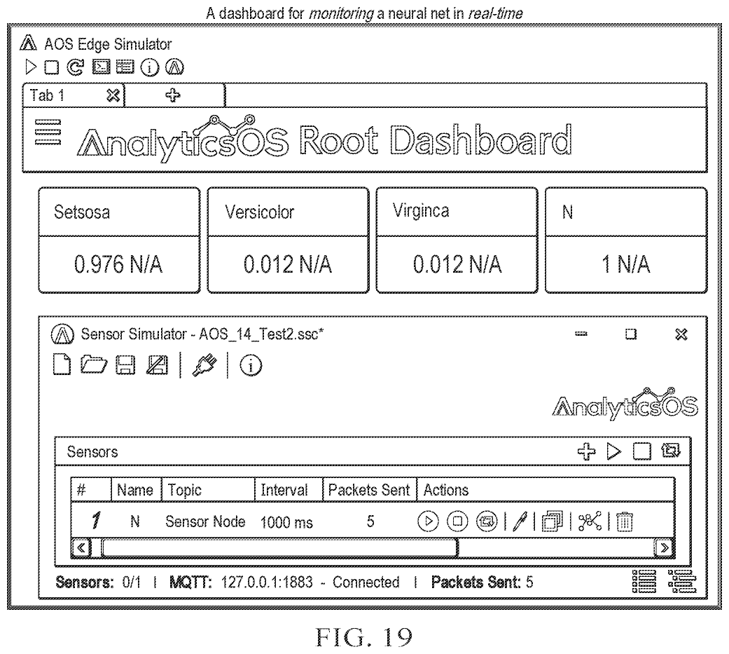

A benefit of adopting the Evolved AI system architecture is the ability to literally copy/paste the tuned model into Predictive and Prescriptive Analytics for Systems Under Variable Operations (Reference U.S. Pat. No. 10,795,337, Oct. 6, 2020) for real-time implementation. FIG. 18 shows a model for processing a neural net architecture in real-time and FIG. 19 shows a corresponding dashboard for monitoring a neural net architecture in real-time.

In one embodiment, Evolved AI may be integrated such that, upon optimization, the model is automatically sent to the real-time environment, instead of copying/pasting. In another embodiment, Evolved AI may be architected to run off-line, at some pre-determined frequency to re-optimize (or train) the weights. The frequency may be determined by time or the amount of data collected or some other criterion such that the Evolved AI system architecture is continually learning and updating (synchronous or asynchronous) its real-time implementation accordingly. Alternatively, weights may be updated in real-time as information (data) arrives. Two embodiments of this approach include signal processing techniques (e.g., Kalman filtering) for direct real-time weight updates or in parallel where weights are updated upon convergence.

Evolved AI and its real-time deployment do not have to be collocated. An embodiment might include real-time deployment to the cloud or some future entity executing the real-time instantiation. Current practical deployments could include disconnected systems related to transportation, logistics, or complex factory processes. Learning continually and faster without having to interact with the system is a desirable quality.

### Evolved AI Advantages

Neural nets have been criticized for being shallow. Little innate knowledge is required on behalf of the practitioner, and architectural selection becomes an exercise in numerical investigation. The arbitrary number of hidden layers and nodes comprise the depth of deep learning. The practitioner is often unable to explain why one architecture is used over another.

Evolved AI, however, allows the practitioner to explain the model architecture. In the Iris example, a single hidden layer was selected. First, this layer is not hidden; and second, it's only there for one skilled in the art to recognize it as such and to organize the nodes. Furthermore, there are only three nodes. The justification for only selecting three is there are only three classification types. It makes logical sense to only have three. (Compare this approach with mainstream AI approaches that might include multiple hidden layers and certainly many more nodes.)

Neural nets have been criticized for being greedy and brittle. Big data is required to train/test the model which often breaks when presented with new data. As mentioned previously, Evolved AI can be used to train the model (optimize the weights) given 16% of the Iris data set. Since this set of data constitutes the edge cases, the model is resilient when presented new data.

Neural nets also have been criticized for being opaque. There is a lack of transparency due to the difficulty in understanding the connection between inputs and outputs—especially for deep learning. This unknown opaqueness leaves the user wondering if the architecture can be trusted. In Evolved AI, however, the entire model is transparent. The practitioner can graphically visualize the system architecture and its interconnectedness; see FIG. 17. Also recall the activation function is unnecessary but is retained for one skilled in the art's edification. Evolved AI removes the opaqueness of machine learning “black boxes” so practitioners can easily interpret the results and fully explain how the transparent system works.

When it comes to security, there are three types of threats: adversarial attack, Trojan attack, and model inversion attack. With adversarial attacks, AI systems are confused by tricking it to misclassify data. In a Trojan attack, an environmental change is introduced to cause incorrect learning. For a model-inversion attack, the model is reverse-engineered to see the data that was used to train it—which is presumed to be contained in the neural net weights. To avert all three of these attacks, Evolved AI gives the practitioner control over what and how the model is learning. Furthermore, the learning (optimization) is done off-line and only the optimized (constant) weights are deployed to the real-time environment. Data may not be misclassified, no changes can impact the prior learning, and the training data is dissociated from the trained model.

The foregoing has described a neural network implementation within the Evolved AI system architecture. An important point to recognize is the architecture does not have to be a neural network nor contain any fundamental component of neural network architecture. Furthermore, the architecture may be composed of any mathematical or logical structure.

1. A method of constructing a model of a real system, comprising:
constructing an initial neural-like representation of said real system with a combination of layers, said layers comprising mathematical functions including at least one independent variable;
inputting a first set of known data to said initial neural-like representation to generate a corresponding set of output data, said known data comprising values for said at least one independent variable of said neural-like representation;
feeding said corresponding set of output data of said initial neural-like representation and a second set of known data correlated to said first set of known data, to a comparator, said comparator generating error signals representing a difference between members of said set of output data and correlated members of said second set of known data; and,
iteratively varying a weight parameter of at least one of said combination of terms comprising said initial neural-like representation to produce a refined neural-like representation of said real system until a measure of said error signals is reduced to a value wherein the set of corresponding output data of said refined neural-like representation over a desired range is approximately equivalent to said second set of known data.

2. The method recited in claim 1, wherein said iteratively varying a weight parameter of at least one of said combination of terms includes setting a coefficient of each term to a value between a lower bound and an upper bound.

3. The method recited in claim 1, wherein said combination of terms comprises at least one of a transcendental function, a polynomial function, and a Boolean function.

4. The method recited in claim 1, wherein said first set of known data and said second set of known data respectively comprise known input data and corresponding known output data for said real system.

5. The method as recited in claim 1, wherein said first set of known data and said second set of known data are a subset of all known data for said real system.

6. The method recited in claim 5, wherein said subset of all known data is utilized to produce said refined neural-like representation of said system and remaining data of said all known data is utilized to test said refined neural-like representation for coherence over a fuller range of data.

7. The method recited in claim 1, wherein said measure of said error signals corresponds to a minimum error signal for the first and second sets of known data.

8. The method recited in claim 1, wherein said measure of said error signals is a log-loss value of said error signals.

9. A system for constructing an artificial intelligence (AI) neural-like model of a real system, comprising:
a processor; and,
a memory, said memory storing instructions which, when executed by said processor, are operative to:
construct an initial neural-like representation of said real system with a combination of terms, said terms comprising mathematical functions including at least one independent variable;
input a first set of known data to said initial neural-like representation to generate a corresponding set of output data, said known data comprising values for said at least one independent variable of said neural-like representation;
feed said corresponding set of output data of said initial neural-like representation and a second set of known data, correlated to said first set of known data, to a comparator, said comparator generating error signals representing a difference between members of said set of output data and correlated members of said second set of known data;
iteratively vary a parameter of at least one of said combination of terms comprising said initial neural-like representation to produce a refined neural-like representation of said real system until a measure of said error signals is reduced to a value wherein the set of corresponding output data of said refined neural-like representation over a desired range is approximately equivalent to said second set of known data.

10. The system recited in claim 9, wherein iteratively varying a weight parameter of at least one of said combination of terms includes setting a coefficient of each term to a value between a lower bound and an upper bound.

11. The system recited in claim 9, wherein said combination of terms comprises at least one of a transcendental function, polynomial function, and a Boolean function.

12. The system recited in claim 9, wherein said first set of known data and said second set of known data respectively comprise known input data and corresponding known output data for said real system.

13. The system as recited in claim 9, wherein said first set of known data and said second set of known data are a subset of all known data for said real system.

14. The system recited in claim 13, wherein said subset of all known data is utilized to produce said refined neural-like representation of said system and remaining data of said all known data is utilized to test said refined neural-like representation for coherence over a fuller range of data.

15. The system recited in claim 9, wherein said measure of said error signals corresponds to a minimum error signal for the first and second sets of known data.

16. The system recited in claim 9, wherein said measure of said error signals is a log-loss value of said error signals.
